(19) United States
(12) Patent Application Publication
(10) Pub. No.: US 2004/0233319 A1
(43) Pub. Date: Nov. 25, 2004

(54) Image sensing module

(76) Inventors: Kuo-Liang You, Shinchu (TW); Yo-Chih Huang, Taoyuan (TW)

Correspondence Address: FROMMER LAWRENCE & HAUG, 745 FIFTH AVENUE- 10TH FL., NEW YORK, NY, 10151, US

(21) Appl. No.: 10/704,473

(22) Filed: Nov. 7, 2003

(30) Foreign Application Priority Data
May 8, 2003 (TW) 092208422

(51) Int. Cl. H04N 5/225

(52) U.S. Cl. 348/340

(57) ABSTRACT

An image sensing module includes a circuit board, an image sensor mounted on and coupled electrically to the circuit board, an optical lens unit mounted on the circuit board and operably associated with the image sensor such that the image sensor acquires an object image through the optical lens unit and generates an electrical output corresponding to the object image, and an electrical connector mounted on the circuit board and having an input port coupled electrically to the circuit board so as to receive the electrical output of the image sensor, and an output port adapted to be coupled electrically to a ribbon cable.

### CROSS-REFERENCE TO RELATED APPLICATION

This application claims priority of Taiwanese Application No. 092208422, filed on May 8, 2003.

### BACKGROUND OF THE INVENTION

1. Field of the Invention

The invention relates to an image sensing module, more particularly to an image sensing module adapted to be connected to an external device via a ribbon cable.

2. Description of the Related Art

FIGS. 1 and 2 illustrate a conventional image sensing module that includes a flexible printed circuit board 10, an image sensor 11 mounted on and coupled electrically to the flexible printed circuit board 10, a lens seat 20 mounted on the flexible printed circuit board 10, and an optical lens 21 mounted on the lens seat 20 and operably associated with the image sensor 11 such that the image sensor 11 acquires an object image through the optical lens 21 and generates an electrical output corresponding to the object image. The flexible printed circuit board 10 has one edge formed with a set of board edge contacts 12 to permit direct electrical connection with an external device 3, such as a digital camera or a mobile phone, via a board edge connector of the external device 3 so that the electrical output of the image sensor 11 can be received by the external device 3.

FIG. 3 illustrates another conventional image sensing module that differs from the aforesaid conventional image sensing module of FIG. 1 mainly in the size and shape of the flexible printed circuit board 10′.

It is noted that each of the flexible printed circuit boards 10, 10′ of the aforesaid conventional image sensing modules is configured with a shape corresponding to requirements of an appliance to be applied with the conventional image sensing module. For the flexible printed circuit board having a relatively large size, fabrication costs are increased. Furthermore, different testing devices are needed for conventional image sensing modules including different shapes of the flexible printed circuit boards.

### SUMMARY OF THE INVENTION

Therefore, the object of the present invention is to provide an image sensing module that can be coupled electrically to an external device via a ribbon cable so as to overcome the aforesaid drawbacks of the prior art.

According to the present invention, an image sensing module comprises:

a circuit board having a lens mounting portion, and a connector mounting portion connected to the lens mounting portion;

an image sensor mounted on the lens mounting portion and coupled electrically to the circuit board;

an optical lens unit mounted on the lens mounting portion of the circuit board and operably associated with the image sensor such that the image sensor acquires an object image through the optical lens unit and generates an electrical output corresponding to the object image; and

an electrical connector mounted on the connector mounting portion of the circuit board and having an input port coupled electrically to the circuit board so as to receive the electrical output of the image sensor, and an output port adapted to be coupled electrically to a ribbon cable.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic front view of a conventional image sensing module;

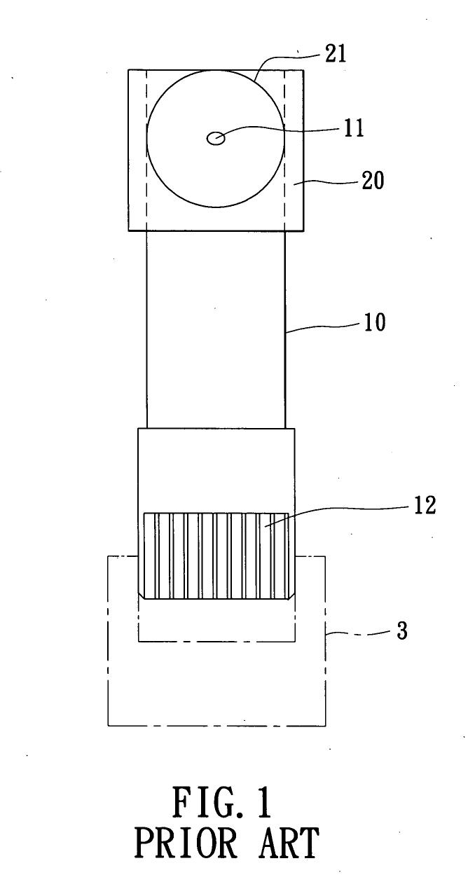

FIG. 2 is a schematic side view of the conventional image sensing module;

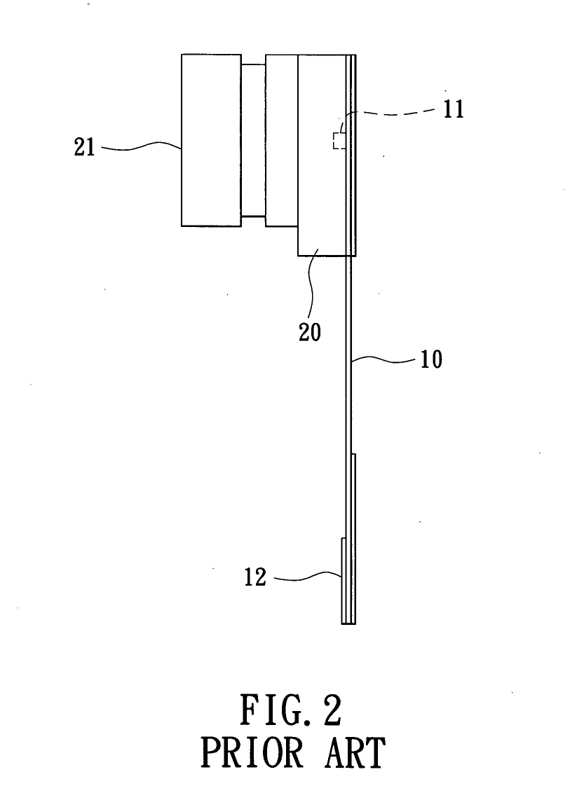

FIG. 3 is a schematic front view of another conventional image sensing module;

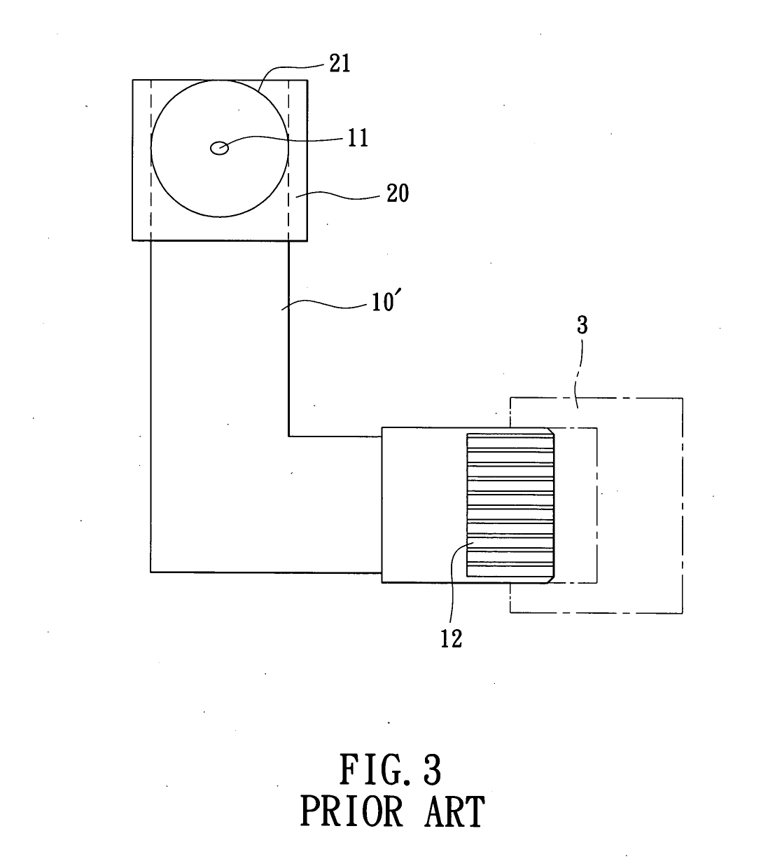

FIG. 4 is a schematic front view showing the preferred embodiment of an image sensing module according to the present invention; and

FIG. 5 is a schematic side view showing the preferred embodiment.

### DETAILED DESCRIPTION OF THE PREFERRED EMBODIMENT

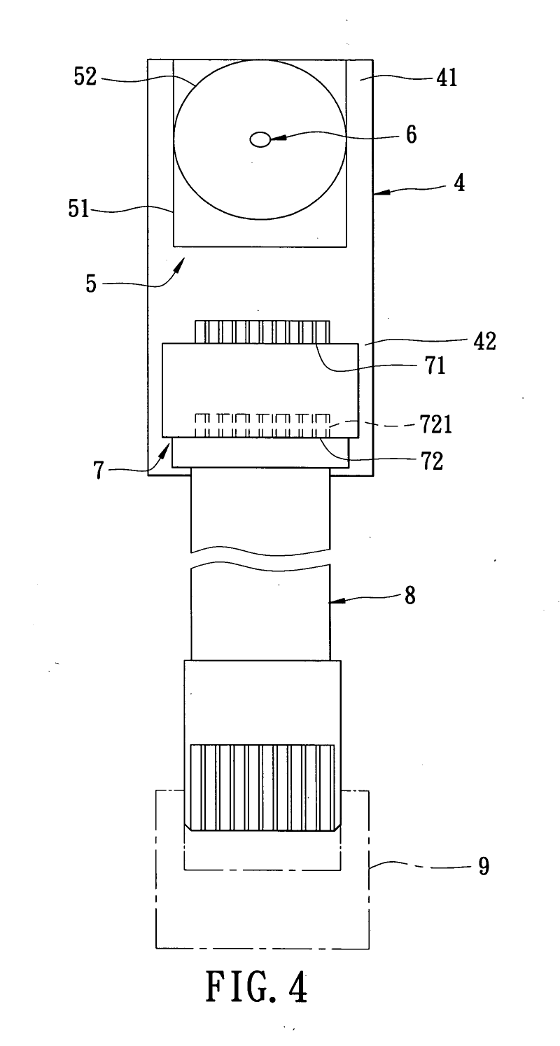

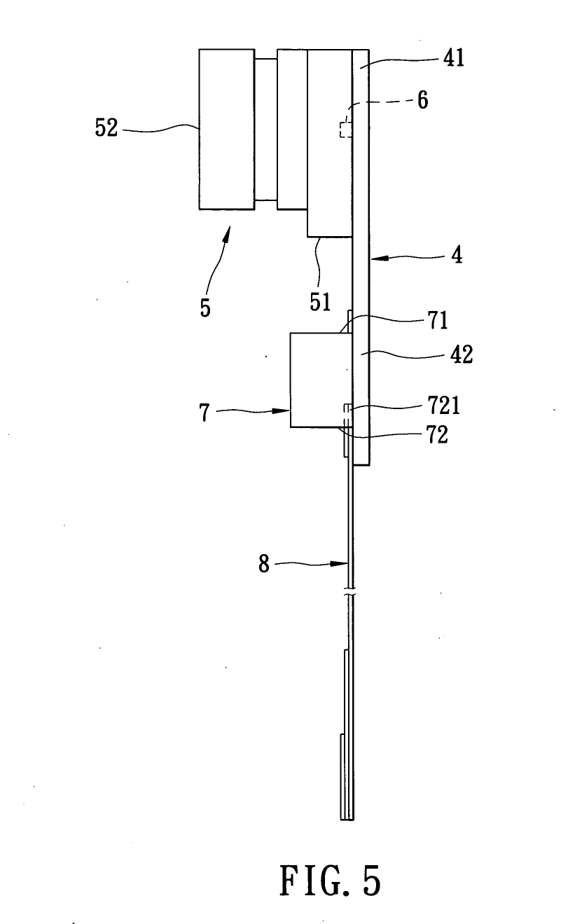

Referring to FIGS. 4 and 5, the preferred embodiment of an image sensing module according to the present invention is shown to include a circuit board 4, an image sensor 6, an optical lens unit 5, and an electrical connector 7.

The circuit board 4 has a lens mounting portion 41, and a connector mounting portion 42 connected to and the lens mounting portion 41. In this embodiment, the circuit board 4 is a rigid printed circuit board. In other embodiments, the circuit board 4 may be a flexible printed circuit board.

The image sensor 6 is mounted on the lens mounting portion 41 and is coupled electrically to the circuit board 4 in a conventional manner.

The optical lens unit 5 is mounted on the lens mounting portion 41 of the circuit board 4 and is operably associated with the image sensor 6 in a conventional manner such that the image sensor 6 acquires an object image through the optical lens unit 5 and generates an electrical output corresponding to the object image. In this embodiment, the optical lens unit 5 includes a lens seat 51 mounted on the lens mounting portion 41 of the circuit board 4, and an optical lens 52 mounted on the lens seat 51.

The electrical connector 7 is mounted on the connector mounting portion 42 of the circuit board 4, and has an input port 7i coupled electrically to the circuit board 4 using known surface mount technology so as to receive the electrical output of the image sensor 6, and an output port 72 adapted to be coupled electrically to one end of a ribbon cable 8. As such, when the other end of the ribbon cable 8 is coupled electrically to an external device 9, the electrical output of the image sensor 6 can be transmitted to the external device 9 via the electrical connector 7 and the ribbon cable 8. In this embodiment, the output port 72 of the electrical connector 7 has ten terminals 721 to meet specific requirements of the external device 9.

To sum up, due to the presence of the electrical connector 7, the image sensing module of this invention can be connected electrically to different types of the external devices 9 via a corresponding ribbon cable 8 such that the circuit board 4 has a relatively small size and can be designed to have a uniform shape suitable for a single testing device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An image sensing module comprising:
a circuit board having a lens mounting portion, and a connector mounting portion connected to said lens mounting portion;
an image sensor mounted on said lens mounting portion and coupled electrically to said circuit board;
an optical lens unit mounted on said lens mounting portion of said circuit board and operably associated with said image sensor such that said image sensor acquires an object image through said optical lens unit and generates an electrical output corresponding to the object image; and
an electrical connector mounted on said connector mounting portion of said circuit board and having an input port coupled electrically to said circuit board so as to receive the electrical output of said image sensor, and an output port adapted to be coupled electrically to a ribbon cable.

2. The image sensing module as claimed in claim 1, wherein said circuit board is a rigid printed circuit board.

3. The image sensing module as claimed in claim 1, wherein said circuit board is a flexible printed circuit board.

4. The image sensing module as claimed in claim 1, wherein said optical lens unit includes a lens seat mounted on said circuit board, and an optical lens mounted on said lens seat.
